(19) United States
(12) Patent Application Publication
(10) Pub. No.: US 2008/0175969 A1
(43) Pub. Date: Jul. 24, 2008

(54) Non dairy frozen dessert containing maltitol with very low calorie content, and method for preparing the same

(76) Inventors: Clement Opawumi, Townsend, DE (US); Charles E. Kuenzle, Newark, DE (US)

Correspondence Address: TOD R NISSLE, PO BOX 55630, PHOENIX, AZ, 85078, US

(21) Appl. No.: 11/986,303

(22) Filed: Nov. 20, 2007

Related U.S. Application Data
(60) Provisional application No. 60/860,125, filed on Nov. 20, 2006.

(51) Int. Cl. A23G 3/48; A23G 9/34

(52) U.S. Cl. 426/548; 426/660

(57) ABSTRACT

A non dairy frozen dessert containing polyols and high intensity sweeteners and has a low and reduced calorie content.

This application claims priority based on provisional patent application Ser. No. 60/860,125 filed Nov. 20, 2006.

### FIELD OF DISCLOSURE

The present disclosure relates to a no-sugar-added (NSA) non-dairy frozen dessert product without the use of conventional sucrose and high fructose corn syrup sweeteners.

### BACKGROUND

Dairy-based, frozen desserts containing polyols blended with high intensity sweeteners in finished product applications are well known. In addition, most of the frozen desserts contain the traditional combinations of sucrose and corn syrup as the sweetener components. However, new compositions of polyols and high intensity sweeteners with low and reduced calorie content are not known. These new product compositions fulfill an unmet need in the market place for healthy alternatives to sugar and high fructose corn syrup.

### SUMMARY OF THE DISCLOSURE

The disclosure relates to compositions of a non-dairy frozen dessert with very low calorie content and no-sugar-added. It also relates to the method for preparing this frozen dessert. The term “frozen dessert” is intended to mean any deep frozen food preparation intended to be consumed as it is taken out of a freezer or refrigerator, said food preparation being in particular in the form of a fruit sorbet or sherbet, water ice or an ice cream.

A process of producing this frozen dessert utilizes the advantage of alternative sweetener technology apart from the traditional sucrose and corn syrup combinations to significantly reduce the calories of the finished product. In addition, this alternative sweetener technology has benefits and properties, which produce products having superior organoleptic and textural properties.

The resulting product will be a mixture of, but not limited to: water, a polyol, such as preferably maltitol, erythritol or sorbitol, polyglycitol, polydextrose, stabilizers and a high intensity sweetener, such as preferably Sucralose, Acesulfame potassium, and/or stevia components such as rebaudioside A. Other ingredients such as starch, maltodextrin, fiber, flavors, colorants, acids, extracts, fruit concentrates, fruit purees, syrups (natural and artificial), minerals, and the like, may be incorporated into the compositions.

### Benefits of Composition

With an obesity epidemic plaguing the nation, the need for healthier food products that remain palatable has forced manufacturers to shift their objectives. Many consumers are demanding more choices for healthier diets—from higher protein foods to foods with lower sugar and calories. This new product will allow for the food industry to offer low calorie and no sugar added food with superior organoleptic and textural properties.

### DETAILED DESCRIPTION OF THE DISCLOSURE

The disclosure relates to compositions of a non-dairy frozen dessert with very low calorie content and no-sugar-added. It also relates to the method for preparing this frozen dessert. The term “frozen dessert” is intended to mean any deep frozen food preparation intended to be consumed as it is taken out of a freezer or refrigerator, said food preparation being in particular in form of a fruit sorbet or sherbet, water ice or an ice cream.

A process of producing this frozen dessert utilizes the advantage of alternative sweetener technology apart from the traditional sucrose and corn syrup combinations to significantly reduce the calories of the finished product. In addition, this alternative sweetener technology has benefits and properties, which produce product having superior organoleptic and textural properties.

The resulting product will be a mixture of, but not limited to: water, a polyol, such as preferably maltitol, erythritol, or sorbitol, polyglycitol, polydextrose, stabilizers and a high intensity sweetener, such as preferably Sucralose, Acesulfame potassium, and/or stevia components such as rebaudioside A. Other ingredients such as starch, maltodextrin, fiber, flavors, colorants, acids, extracts, fruit concentrates, fruit purees, syrups (natural and artificial), minerals, and the like, may be incorporated into the compositions.

In one embodiment, the disclosure relates to a liquid composition comprising water, maltitol syrup, polyglycitol, polydextrose, stabilizer, fruit juice concentrate and a high intensity sweetener, such as preferably aspartame and/or acesulfame potassium. Other ingredients such as starch, maltodextrin, fiber, flavors, colorants, acids, extracts, fruit concentrates, fruit purees, syrups (natural and artificial), minerals, and the like, may be incorporated into the compositions.

In another embodiment, the disclosure relates to a liquid composition comprising water, maltitol syrup, polyglycitol, polydextrose, stabilizer, fruit juice concentrate and a high intensity sweetener, fruit puree, a colorant, an artificial flavor and a high intensity sweetener, such as preferably sucralose. Other ingredients such as starch, maltodextrin, fiber, flavors, colorants, acids, extracts, fruit concentrates, fruit purees, syrups (natural and artificial), minerals, and the like, may be incorporated into the compositions.

In another embodiment, the disclosure relates to a liquid composition comprising water, maltitol syrup, polyglycitol, polydextrose, stabilizer, fruit juice concentrate and a high intensity sweetener, fruit puree, a colorant, an artificial flavor and a high intensity sweetener, such as preferably a stevia component such as rebaudioside A. Other ingredients such as starch, maltodextrin, fiber, flavors, colorants, acids, extracts, fruit concentrates, fruit purees, syrups (natural and artificial), minerals, and the like, may be incorporated into the compositions.

In another embodiment, the disclosure relates to a liquid composition comprising 56% water, 8% maltitol syrup, 5% polyglycitol, 4% polydextrose, 0.40% stabilizer, 12% fruit juice concentrate, such as white grape juice concentrate, 0.06% high intensity sweetener such as sucralose, 15% fruit puree such as strawberry puree, 0.20% colorant such as red dye # 40, and 0.60% flavor such as strawberry WONF.

In producing the liquid compositions of the present disclosure, there are preferred amounts of water, maltitol syrup, polydextrose, polyglycitol, stabilizer, high intensity sweetener, fruit puree, fruit juice concentrate, flavor and color when used. More particularly, it is preferred to use the following ingredients in the ranges of:

| | | |
|---|---|---|
| Water | 35% to 75% | (w/w) |
| Maltitol Syrup | 4% to 20% | (w/w) |
| Polydextrose | 2% to 10% | (w/w) |
| Polyglycitol | 2% to 10% | (w/w) |
| Stabilizer | 0.05% to 2% | (w/w) |
| High Intensity Sweetener | 0.005% to 0.50% | (w/w) |
| Fruit Puree | 5% to 26% | (w/w) |
| Fruit Juice Concentrate | 1% to 18% | (w/w) |
| Flavor | 0.05% to 5% | (w/w) |
| Color | 0.01% to 5% | (w/w) |

In producing the liquid compositions of the present disclosure, there are still further preferred amounts of water, maltitol syrup, polydextrose, polyglycitol, stabilizer, high intensity sweetener, fruit puree, fruit juice concentrate, flavor and color when used More particularly, it is preferred to use the following ingredients in the ranges of:

| | | |
|---|---|---|
| Water | 45% to 65% | (w/w) |
| Maltitol Syrup | 7% to 11% | (w/w) |
| Polydextrose | 3% to 6% | (w/w) |
| Polyglycitol | 3% to 6% | (w/w) |
| Stabilizer | 0.20% to 0.06% | (w/w) |
| High Intensity Sweetener | 0.02% to 0.08% | (w/w) |
| Fruit Puree | 10% to 18% | (w/w) |
| Fruit Juice Concentrate | 9% to 14% | (w/w) |
| Flavor | 0.3% to 0.8% | (w/w) |
| Color | 0.1% to 0.4% | (w/w) |

### EXAMPLE 1

The compositions of the present disclosure may be prepared by any conventional technique. In the present disclosure, the following is an example in the case of a liquid composition. In this example there is produced a non-dairy frozen dessert containing maltitol using the following method:
(a) The Polydextrose, polyglycitol, and stabilizer are blended together to uniformity to form a homogenous dry ingredient blend.
(b) Water is metered, or weighed into a separate mixing vessel;
(c) Agitation is engaged and the polyol is added, which in Example 1 is maltitol syrup (Maltisweet™ IC);
(d) The high intensity sweetener, which in the Example 1 is sucralose, is added to the water and polyol mixture while under agitation.
(e) The dry ingredient blend, which in the Example 1 is the polydextrose, polyglycitol, and stabilizer are added to the mixture while under agitation. The mixture is then mixed to uniformity.
(f) The resulting mixture is then pasteurized followed by immediate cooling at 38 deg. F.
(g) Agitation is engaged and the Fruit Puree concentrate is added, which in Example 1 is strawberry puree.
(h) The fruit juice concentrate is then added, which in Example 1 is the white grape juice concentrate.
(i) The color and flavor are added, which in Example 1 are the Red # 40 and the Strawberry WONF. The mixture is then blended to uniformity.
(j) Further additives and ingredients may be added at this stage and mixed to uniformity.
(k) The mixture is then aged for 10 hours at a temperature of 38 deg. F. followed by freezing to a 35% overrun.

The liquid composition was prepared by mixing the following ingredients at the prescribed percentages.

| | | |
|---|---|---|
| Water | 55.84% | (w/w) |
| Maltitol Syrup (Maltisweet ™ IC) | 9.00% | (w/w) |
| Polydextrose | 4.50% | (w/w) |
| Polyglycitol (Stabilite ™ SD30 Polyglycitol powder) | 4.50% | (w/w) |
| Stabilizer (TIC Dairy Blend 101-B) | 0.40% | (w/w) |
| High Intensity Sweetener (Sucralose-25% Solution) | 0.06% | (w/w) |
| Fruit Puree (Strawberry Puree Conc.-Kerr 28 Brix) | 14.00% | (w/w) |
| Fruit Juice Concentrate (100% White Grape Juice Conc.) | 11.00% | (w/w) |
| Flavor (Strawberry WONF Flavor DM #25317) | 0.50% | (w/w) |
| Color (Red 40-10% Solution) | 0.20% | (w/w) |

The process can be carried out by a batch process, a continuous process or a combination of the two. The order of addition of the ingredients can also be varied to yield acceptable product depending upon the types of ingredients being blended to together and their respective physical characteristics.

This disclosure has been described with reference to various specific and illustrative embodiments and techniques. However, one skilled in the art will recognize that many variations and modifications may be made while retaining within the spirit and scope of the disclosure and the claims.

We claim:

1. A non-dairy frozen dessert composition comprising water, maltitol syrup, polydextrose, polyglycitol, stabilizer, and high intensity sweetener.

2. The composition according to claim 1 further comprising polyols such as sorbitol, erythritol, maltitol, lactitol and xylitol.

3. The composition according to claim 1 further comprising fruit concentrate.

4. The composition according to claim 1 further comprising fruit puree.

5. The composition according to claim 1 further comprising artificial and natural flavors.

6. The composition according to claim 1 further comprising colorants.

7. The composition according to claim 1 further comprising natural high intensity sweetener such as stevia, rebaudioside A, thaumatin, lo han guo, or monatin.

8. The composition according to claim 1 further comprising synthetic high intensity sweetener such as sucralose, neotame, aspartame, or acesulfame potassium.

9. The composition according to claim 1 further comprising a fiber such as inulin.

10. The compositions of claim 1 used with or without other ingredients or additives such as binders, active or inactive (inert) ingredients which are homogeneous or non-homogeneous, non-segregating and non-hygroscopic for use in an array of applications such as, but not limited to, dietetic products, pharmaceuticals, food stuffs, and confectionery.

11. A non-dairy frozen dessert composition comprising water, polyol syrup, polydextrose, polyglycitol, stabilizer, and high intensity sweetener.
